(19) United States
(12) Patent Application Publication
(10) Pub. No.: US 2017/0025041 A1
(43) Pub. Date: Jan. 26, 2017

(54) APPARATUS AND METHOD FOR TEACHING PERSONS

(71) Applicant: Hagar Shema, Bet Arif (IL)

(72) Inventor: Hagar Shema, Bet Arif (IL)

(21) Appl. No.: 15/215,042

(22) Filed: Jul. 20, 2016

Related U.S. Application Data
(60) Provisional application No. 62/197,033, filed on Jul. 26, 2015.

(30) Foreign Application Priority Data
Mar. 27, 2016 (IL) 244777

(51) Int. Cl. G09B 19/08; G06F 3/02; G06F 3/0488; G06F 3/14; G06F 3/0482

(52) U.S. Cl. CPC G09B 19/08; G06F 3/14; G06F 3/0482; G06F 3/0488; G06F 3/02

(57) ABSTRACT

A method and apparatus for interacting with a person receiving a sequence of inputs from a person, the sequence of inputs represent a sequence of symbols, multiple sections of an input unit are associated with the symbols, such that the person presses multiple sections to represent a predefined sequence. At least some of the sensors are associated with sections of the input unit. Processing the information sensed by the sensors and identifying the sequence of symbols from the sequence of inputs inputted. Comparing the identified sequence with a sequence stored in a repository. Outputting audio or visual signals in accordance with the identification of the sequence. The input unit having two or more regions divided into two or more different symbol types, one of the symbol types is letters, the sequence of inputs comprising letters and additional symbols, and multiple sections in each region.

The present application claims priority from Israeli Application No. 244777, filed on Mar. 27, 2016, and U.S. Provisional Application No. 62/197,033, filed on Jul. 26, 2015, the entire disclosures thereof are incorporated herein by reference.

### FIELD OF THE INVENTION

The application generally relates to the field of teaching, more specifically to teaching persons using an interactive apparatus

### BACKGROUND OF THE INVENTION

Teaching children is sometimes challenging, especially in view of many alternatives for children to spend their time on, such as video games, TV and others. Hence, it is desired to find creative ways to get children's attention to learn, for example via educational software. In addition, it is desired to find an apparatus in which children can learn how to read while not sitting in front of a screen.

### SUMMARY OF THE INVENTION

It is an object of the present invention to disclose an apparatus for interacting with a person, the apparatus comprises an input unit for receiving a sequence of inputs from a person, the sequence of inputs represent a sequence of symbols, multiple sections of the input unit are associated with the symbols, such that the person presses multiple sections to represent a predefined sequence; a plurality of sensors for sensing presses on the input unit, at least some of the sensors are associated with sections of the input unit; a memory unit which contains a repository of words and predefined character strings; a processor for processing the information sensed by the sensors, in order to identify the sequence of symbols from the sequence of inputs inputted by the person on the input unit and compare the identified sequence with a sequence stored in the repository; an output unit communicating with the processor and configured to output audio or visual signals in accordance with the identification of the sequence performed by the processor; wherein the physical input unit comprises two or more regions divided into two or more different symbol types, one of the symbol types is letters, the sequence of inputs comprising letters and additional symbols, and multiple sections in each region. The input unit may be a physical input unit such as a keyboard or a carpet toy used by a child user. The input unit may comprise virtual keys controlled by a computer, as detailed below in the Wii example.

In some cases, one of the two or more regions comprises two or more NIKKUD signs. In some cases, the predefined character strings of inputs stored in the memory unit comprises diverse operation types. In some cases, the physical input unit is made of an elastic foldable material. In some cases, the material is selected from fabric, nylon, PVC, rubber, silicon and a combination thereof.

In some cases, the output unit has an interface to an illuminator that expresses indications on inputs received from a person, by the sensors in accordance with user operation or some predefined rules or commands from the processor. In some cases, the apparatus further comprises a wireless transceiver that transmits signals to a mobile device, to enable the mobile device to produce an audio or visual output signal, said wireless transceiver is designed to receive input from the mobile device and to transmit it to the processor.

In some cases, the apparatus further comprises a button used by a user to receive feedback on whether or not the sequence of symbols inputted by the user match a sequence stored in the memory unit. In some cases, the apparatus further comprises a physical socket into which a cable can be plugged, for connecting an external computerized device in order to add words or character strings to the memory unit. In some cases, the apparatus further comprises a virtual socket which can communicate with a wireless device, for connecting to an external computerized device in order to add words or character strings to the memory unit.

It is another object of the present invention to disclose a method for interacting with a person, comprising receiving a sequence of inputs from a person, the sequence of inputs represent a sequence of symbols, multiple sections of the physical input unit are associated with the symbols, such that the person presses multiple sections to represent a predefined sequence; sensing presses on the physical input unit, at least some of the sensors are associated with sections of the physical input unit; processing the information sensed by the sensors; identifying the sequence of symbols from the sequence of inputs inputted by the person on the physical input unit; comparing the identified sequence with a sequence stored in a repository; output audio or visual signals in accordance with the identification of the sequence performed by the processor; wherein the physical input unit comprises two or more regions divided into two or more different symbol types, one of the symbol types is letters, the sequence of inputs comprising letters and additional symbols, and multiple sections in each region.

In some cases, at least a portion of the method is performed in a computerized device communicating with the apparatus having a physical input. For example, the comparison and output are performed by a mobile device.

### BRIEF DESCRIPTION OF THE FIGURES

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 shows a circular physical input unit for an interactive apparatus for teaching persons, according to exemplary embodiments of the subject matter;

FIG. 2 shows a rectangular physical input unit for an interactive apparatus for teaching persons, according to exemplary embodiments of the subject matter

FIG. 3 shows a schematic components of an interactive apparatus for teaching persons, according to exemplary embodiments of the subject matter;

FIG. 4 shows a computerized environment in which a user uses an interactive apparatus for teaching persons via another electronic device, according to exemplary embodiments of the subject matter;

FIG. 5 shows a method of interactively teaching persons, according to exemplary embodiments of the subject matter.

### DESCRIPTION OF THE INVENTION

The present invention discloses an interactive apparatus and method for teaching persons how to spell and mathematics. The apparatus comprises a physical input unit via which the user inputs symbols, such as letters, numbers, punctuation marks such as “comma” or “,”, mathematical signs such as “plus” or “+” and vowel (or NIKKUD, or NIKKUD, vocalization or vowelization) signs such as “kubutz” the like. The physical input unit comprises a plurality of sections, each section represents a symbol. For example, 26 sections that represent the 26 letters in the English language. The physical input unit may be a sheet of material, such as fabric of any kind, which covers electrical circuitry. In some other cases, the physical input is a touch screen, in which a software connected to the touch screen converts the location of the touches into the symbols. The user's input as inputted into the input unit is then transmitted to a processor or to an integrated circuit for analysis, for example to check whether a sequence of letters matches a word stored in the memory of the integrated circuit. This way, the user of the apparatus can learn how to spell words or expressions correctly. The apparatus is interactive in a way that the user's input is checked by a computerized or electronic module in the apparatus or connected to the apparatus, and the apparatus outputs a feedback according to the user's input, for example a positive output in case the user spelled a word correctly. The user may use one or more cards to assist her/him in the learning process, for example a card that shows a sequence of letters or another type of symbols. For example, a card may show an object and some of the letters of the name of the object. The cards may have information on one side, such information can be scanned or otherwise identified by an adaptive module in the interactive apparatus, such as a barcode scanner or a camera. After placing the card in a predefined position in order to identify the information, the user presses the sections that represent symbols, such as letters, which appear in the card, or in the word that represents the card. For example, inputs a sequence of letters. The interactive apparatus compares the sequence of letters inputted by the user to a predefined sequence that matches the card. The user may press a control button, or section, to receive a feedback on whether or not the sequence of symbols inputted by the user match a sequence stored in the interactive apparatus.

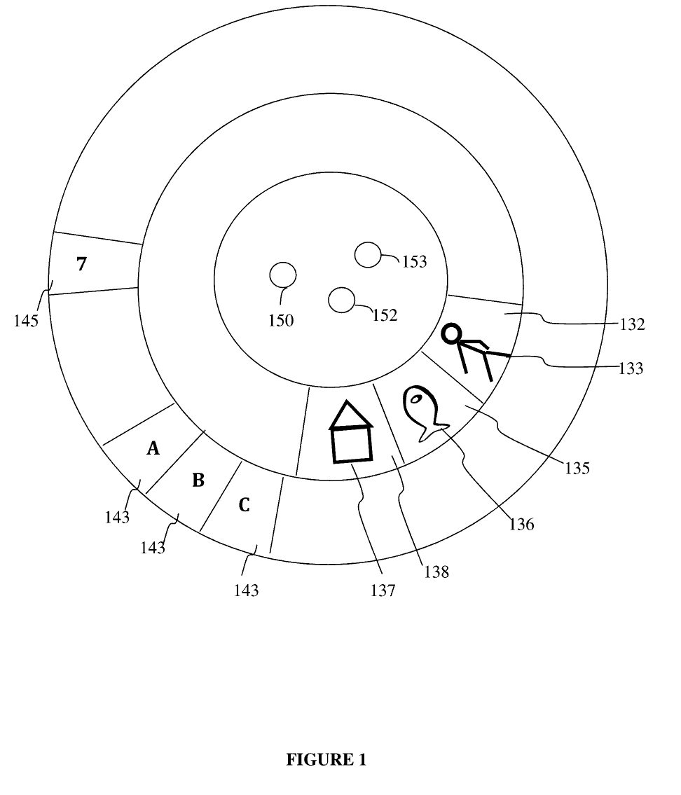

FIG. 1 shows a circular physical input unit for an interactive apparatus for teaching persons, according to exemplary embodiments of the subject matter. The physical input unit 100 comprises various electronic modules is at least partially covered by a sheet of material, such as fabric, cardboard or nylon of any kind. In some other cases, the electronic modules of the physical input unit 100 may be stored in a housing, for example in case the physical input unit 100 comprises a touch screen. The electronic modules comprise sensors that sense when the user of the interactive apparatus presses a section of the sheet of material or the touch screen, said section represents a symbol. In some exemplary cases, the apparatus outputs an audio signal in response to pressing a section of the physical input unit. The audio signal may vary according to the pressed section, for example to inform the user of an identified letter or sequence of symbols. In the embodiment of FIG. 1, the physical input unit 100 is of a circular or elliptical shape and divided into regions, some of the regions may be divided into sections that represent symbols, a group of symbols may be positioned in a specific region. In some cases, the physical input unit 100 comprises an external ring 110 is at the circumference of the physical input unit 100, then a secondary ring 130 and an internal region 140. The external ring 110 comprises sections 141, 142, 145 that represents single letters. For example, section 141 represents the letter “A”, section 142 represents the letter “B” and section 145 represents the letter “Z”. In some cases, the external ring 110 comprises 26 sections, as the number of single letters in the English language. In some other cases, the external ring 110 may additionally include a special section for specific commands, such as “cancel”, “delete” and the like. The secondary ring 130 may comprise images of items in specific sections, for example section 132 represents a person 133, section 135 represents fish 136, and section 138 represents a house. The internal region 140 may comprise space for an output unit, for example using LEDs 150, 152 or a speaker 153. In some other cases, the number of layers of sections that represent symbols may be any number from one to a number of layers desired by a person skilled in the art. In some cases, symbols of the various types, such as letters and numbers, may be in the same layer of the physical input unit 100. When the user of the interactive apparatus 100 wishes to learn how to spell a word, he presses the sections of the external ring 110 in the order of the letters. In some languages, the user also inputs vowel signs in addition to the letters. The sensors of the various sections transfer to a processing unit or to an integral circuit that the user pressed them, and the processor or integral circuit determines whether or not the user spelled the word correctly, and outputs a feedback via the output unit accordingly, for example using the LEDs 150, 152 or the speaker 153. Such output may be the speaker outputting the word spelled correctly, for example from a recorded storage of such words. Another input for a correct action is the speaker outputting a sound of clapping arms. In case the user of the interactive apparatus presses on two sections simultaneously, the speaker may generate a unique feedback, for example an audio signal of 1.5 seconds, compared to a standard audio signal of 1 second.

In some cases, for example when teaching Semitic languages such as Arabic and Hebrew, the languages include vocalization signs that represent the vowel of the letters. In such a case, the user will input a letter, and then a vocalization sign (or a vowel sign), before inputting the next letter, or enter a vowel sign before entering the respective letter. In some other cases, the person may press the letter section and the vowel sign section at the same time. In some cases, the output unit of the apparatus may output an audio signal which represents the sequence of letters and vowel signs the person presses.

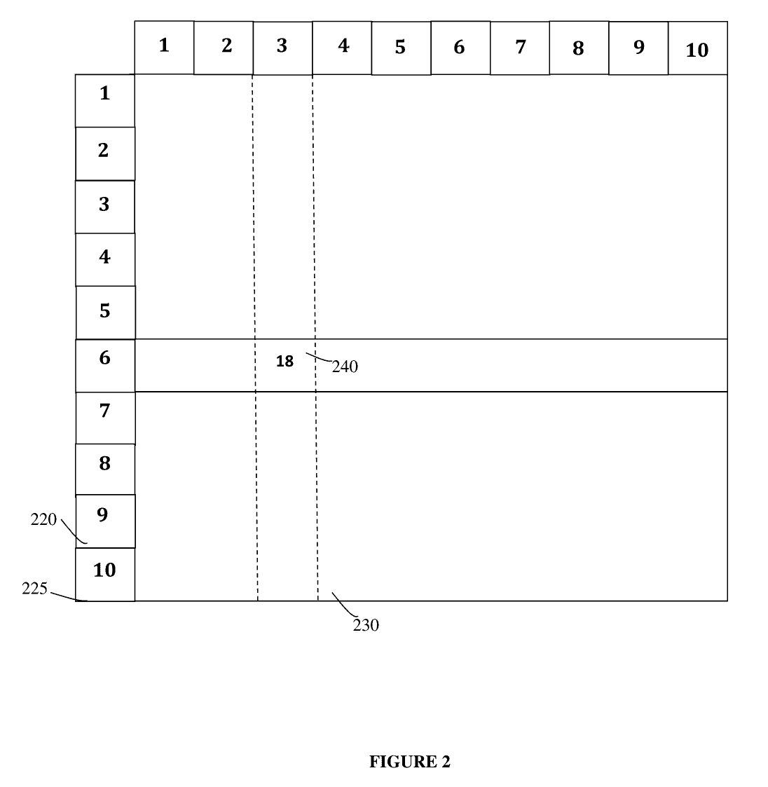

FIG. 2 shows a rectangular physical input unit for an interactive apparatus for teaching persons, according to exemplary embodiments of the subject matter. The rectangular physical input unit 200 of the exemplary embodiment may be used to teach mathematics, for example addition, subtraction, or multiplication. The rectangular physical input unit 200 may comprise two side regions, such as top region 210 and left region 220. The regions may be divided into sections representing numbers. Another region may represent the operator, such as addition or multiplication. Such operator may be updated by the user, for example via a switch, button and the like. The rectangular physical input unit 200 may comprise a main region 230 in which the sections intersect with sections of the top region 210 and the left region 220. For example, section 240 of the main region intersects only with section 3 of the top region 210 and with section 6 of the left region 220. For example, when the user presses section 240 of the main region, the relevant sections in both the top region 210 and the left region 220 are highlighted. This way, the user can understand which two numbers assemble the number he pressed. For example, in case the number “18” was pressed by the user, the two numbers highlighted will be “2” and “9”, according to the location of the number ‘18” in the main region. In some cases, the speaker of the system of the present invention also outputs the names of the numbers, for example “nine” and “two”, or “two times nine”. The processor of the interactive apparatus will identify the relevant sections in the top region 210 and the left region 220 and will illuminate them.

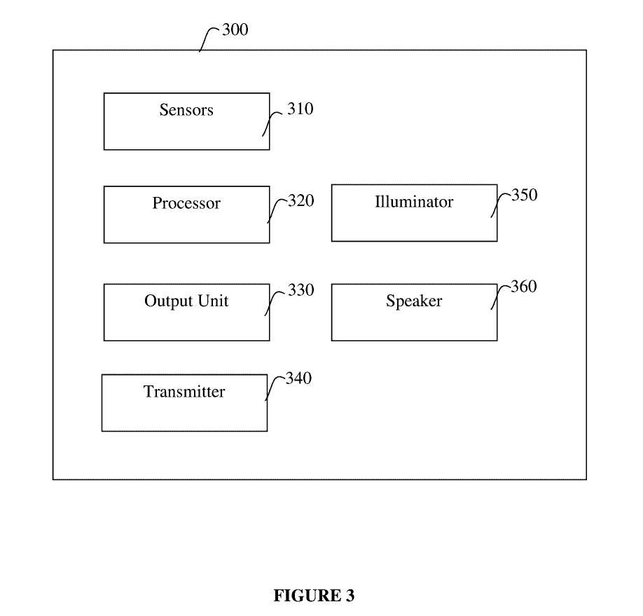

FIG. 3 shows a schematic components of an interactive apparatus for teaching persons, according to exemplary embodiments of the subject matter. The interactive apparatus 300 comprises a plurality of sensors 310 for sensing presses on sections of the physical input unit. The sensors may be attached to fabric and detect a state in which the user of the interactive apparatus presses a section of the physical input unit. In some cases, at least a portion of the plurality of sensors 310 is associated with a single section of the physical input unit.

The interactive apparatus 300 also comprises a processor 320 for processing the information sensed by the plurality of sensors 310 placed under the physical input unit. The processor 320 may be implemented as an integrated circuit. The processor 320 may receive the sequence of sections as inputted by the user and compare the sequence to a predefined expression, for example a sequence of letters is compared to a word to determine whether the user spelled the word correctly or not. In some cases, the processor 320 receives the word from a transmitter 340 that connects to the user's mobile device, for example via Wi-Fi or NFC communication, or is connected to the internet, in which the user inputs a symbol he wishes to spell. The transmitter 340 may be a wireless transmitter that may transmit information concerning the user's preferences on the interactive apparatus to a remote server, or transmit the user's results, for example the number of correct and incorrect results. Such results may be compared with results of the user's friends.

The interactive apparatus 300 also comprises an output unit 330 that outputs a signal in accordance with a predefined rule or in accordance with a command from the processor 320 in case the processor 320 determines whether or not the user was correct. The output unit 330 may comprise LEDs or any other illumination unit 332, such that, for example, red light indicates a wrong spelling and green light indicates a correct answer. The output unit 330 may comprise a speaker 335 that outputs a positive feedback such as “well done” if the user was correct and a negative feedback such as “try again” if the user was incorrect.

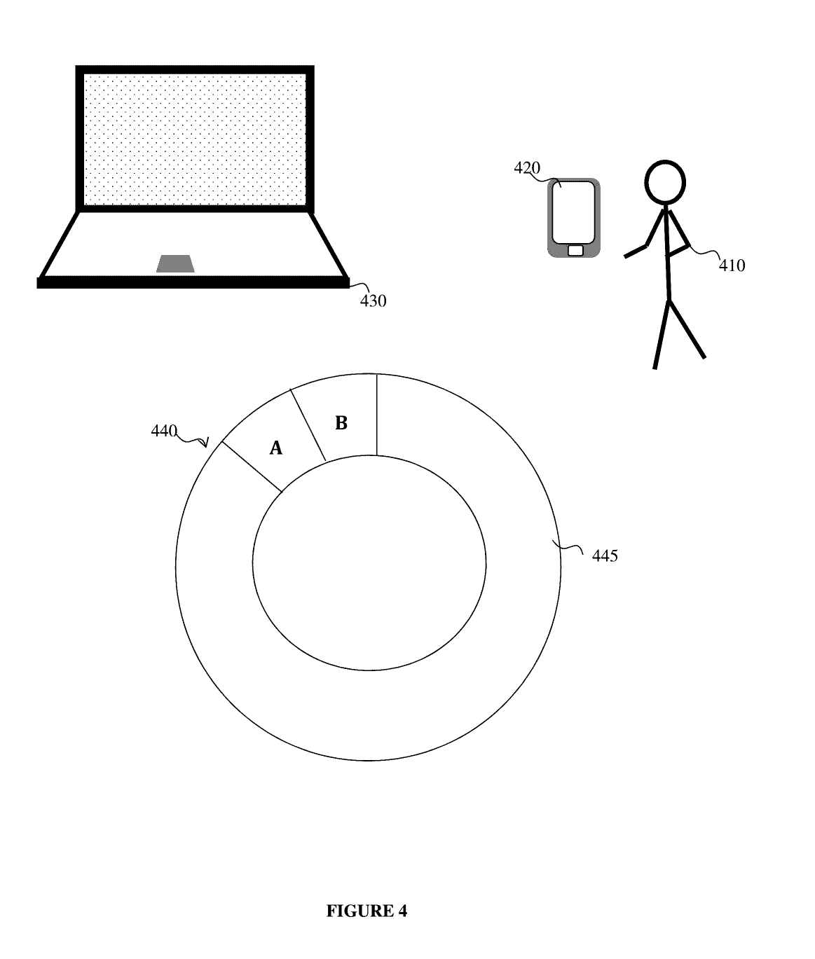

FIG. 4 shows a computerized environment in which a user uses an interactive apparatus for teaching persons via another electronic device, according to exemplary embodiments of the subject matter. The user 410 connects with the interactive apparatus 440 via the electronic device, such as a smartphone 420, laptop, tablet, personal computer 430, television, or any other device in which the user 410 may perform the method disclosed in this environment. The user 410 may select an item from a list of images displayed on the electronic device, the item or the item's name is transmitted to a wireless transceiver 445 of the interactive apparatus 440, and then, when the user 410 inputs the letters to spell the inputted symbol, the processor of the interactive apparatus 440 compares the inputted letters with the letters that assemble the name of the item selected by the user. In such a case, the interactive apparatus 440 enables the user 410 to learn how to spell much more words than in an embodiment in which the words are stored in a memory of the interactive apparatus 440.

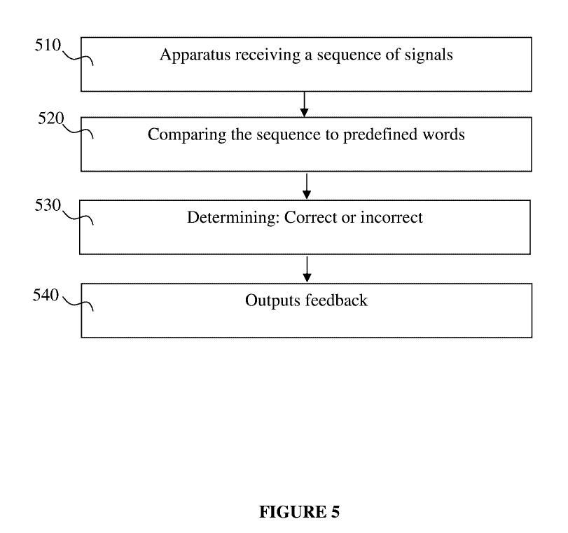

FIG. 5 shows a method of interactively teaching persons, according to exemplary embodiments of the subject matter. Step 510 discloses receiving a sequence of signals via the physical input unit. Such signals may be letters, numbers, arithmetical operators, vowel signs and the like. The sequence of signals may be received via a plurality of sensors positioned in the interactive apparatus. For example, each sensor is positioned under a single section in the physical input unit, as each section represents a single symbol.

Step 520 discloses comparing the sequence of signals that represent a sequence of symbols to a predefined word or expression. Such word may be stored in the memory of the interactive apparatus, for example in a memory of an integrated circuit of the interactive apparatus. In some other cases, the word is transmitted to the interactive apparatus from a remote device.

Step 530 discloses determining whether the user's input is correct or incorrect, for example according to the comparison disclosed above. Then, in step 540, an output is generated by the interactive apparatus and outputted, for example in a way of illumination or sound emitted from the apparatus.

In some cases, at least a portion of the method may be performed using a computerized device communicating with the apparatus of teaching persons. Such computerized device may be a cellular phone, tablet computer, laptop and the like, communicating with the apparatus in a wireless manner or via a communication cable. In some exemplary cases, receiving the sequence of inputs is performed at the apparatus. The inputs are sent to the computerized device, which compares the inputs to a sequence of symbols representing a predefined word in a word repository stored in the computerized device.

The present invention also discloses an apparatus and a computerized system for teaching persons using a display device and one or more sensors. The display device shows various sections, each section represents a symbol, similarly to the physical input unit. The sensors are connected to the person, for example to the person's limbs, such that the person's movements are reflected on the display device, and the person can select a symbol according to a section on the display device. The person can see his virtual location on the display device using a cursor or a pointer that moves on the display device in accordance with the person's movements as detected by the sensors. This way, in case a child has an electronic system, such as Wii for gaming, a software representation of the symbols and the physical input unit is displayed on the display device, enabling the child to learn how to read or spell or calculate, without the requirement to use a physical apparatus disclosed above.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. An apparatus for interacting with a person, the apparatus comprises:
an input unit for receiving a sequence of inputs from a person, the sequence of inputs represent a sequence of symbols, multiple sections of the input unit are associated with the symbols, such that the person presses multiple sections to represent a predefined sequence;
a plurality of sensors for sensing presses on the input unit, at least some of the sensors are associated with sections of the input unit;
a memory unit which contains a repository of words and predefined character strings;
a processor for processing the information sensed by the sensors, in order to identify the sequence of symbols from the sequence of inputs inputted by the person on the input unit and compare the identified sequence with a sequence stored in the repository;
an output unit communicating with the processor and configured to output audio or visual signals in accordance with the identification of the sequence performed by the processor;
wherein the input unit comprises two or more regions divided into two or more different symbol types, one of the symbol types is letters, the sequence of inputs comprising letters and additional symbols, and multiple sections in each region.

2. The apparatus of claim 1, wherein one of the two or more regions comprises two or more NIKKUD signs.

3. The apparatus of claim 2, wherein the predefined character strings of inputs stored in the memory unit comprises diverse operation types.

4. The apparatus of claim 1, wherein the input unit is made of an elastic foldable material.

5. The apparatus of claim 4, wherein the material is selected from fabric, nylon, PVC, rubber, silicon and a combination thereof.

6. The apparatus of claim 1, wherein the output unit has an interface to an illuminator that expresses indications on inputs received from a person, by the sensors in accordance with user operation or some predefined rules or commands from the processor.

7. The apparatus of claim 1, further comprises a wireless transceiver that transmits signals to a mobile device, to enable the mobile device to produce an audio or visual output signal, said wireless transceiver is designed to receive input from the mobile device and to transmit it to the processor.

8. The apparatus of claim 1, further comprises a button used by a user to receive feedback on whether or not the sequence of symbols inputted by the user match a sequence stored in the memory unit.

9. The apparatus of claim 1, further comprises a physical socket into which a cable can be plugged, for connecting an external computerized device in order to add words or character strings to the memory unit.

10. The apparatus of claim 1, further comprises a virtual socket which can communicate with a wireless device, for connecting to an external computerized device in order to add words or character strings to the memory unit.

11. The apparatus of claim 1, wherein the predefined character strings of inputs stored in the memory unit comprises diverse operation types;
wherein the input unit is made of an elastic foldable material;
wherein the apparatus further comprises a wireless transceiver that transmits signals to a mobile device, to enable the mobile device to produce an audio or visual output signal, said wireless transceiver is designed to receive input from the mobile device and to transmit it to the processor;
wherein the apparatus further comprises a communication socket for connecting to an external computerized device in order to add words or character strings to the memory unit from the computerized device.

12. A method for interacting with a person, comprising:
receiving a sequence of inputs from a person, the sequence of inputs represent a sequence of symbols, multiple sections of an input unit are associated with the symbols, such that the person presses multiple sections to represent a predefined sequence;
sensing presses on the input unit, at least some of the sensors are associated with sections of the input unit;
processing the information sensed by the sensors;
identifying the sequence of symbols from the sequence of inputs inputted by the person on the input unit;
comparing the identified sequence with a sequence stored in a repository;
output audio or visual signals in accordance with the identification of the sequence performed by the processor;
wherein the input unit comprises two or more regions divided into two or more different symbol types, one of the symbol types is letters, the sequence of inputs comprising letters and additional symbols, and multiple sections in each region.
